(19) United States
(12) Patent Application Publication
(10) Pub. No.: US 2009/0025423 A1
(43) Pub. Date: Jan. 29, 2009

(54) Teething Necklace and Related Accessories

(75) Inventors: Rebecca O. Durham, Newnan, GA (US); Ashley T. Roberts, Newnan, GA (US)

Correspondence Address: BRYAN W. BOCKHOP, ESQ.;BOCKHOP & ASSOCIATES, LLC, 2375 MOSSY BRANCH DR., SNELLVILLE, GA, 30078, US

(73) Assignee: SONNY AND REED LLC, Newnan, GA (US)

(21) Appl. No.: 12/169,876

(22) Filed: Jul. 9, 2008

Related U.S. Application Data
(60) Provisional application No. 60/951,986, filed on Jul. 26, 2007.

(51) Int. Cl. A44C 15/00; A61J 17/02; A44C 27/00

(52) U.S. Cl. 63/1.11; 606/235; 29/896.4

(57) ABSTRACT

A jewelry item includes a plurality of objects that are made of a material that is suitable for infant teething and that have an outward appearance resembling a stone, a bead or other decorative ornamental object. The objects are made from a material that is a non-toxic substance that will retain its structural integrity when subjected to the forces and environment of a baby chewing on the object. In a method of making a teething necklace, a non-toxic resilient material is formed into a plurality of structures that have an ornamental outward appearance. Each of the plurality of structures are strung together by passing a string member through a longitudinal bore defined by each of the structures.

### CROSS-REFERENCE TO RELATED APPLICATION(S)

This application claims the benefit of U.S. Provisional Patent Application Ser. No. 60/951,986, filed Jul. 26, 2007, the entirety of which is hereby incorporated herein by reference.

### BACKGROUND OF THE INVENTION

1. Field of the Invention

The present invention relates to fashion accessories and, more specifically, to a fashion accessory used to calm a teething infant.

2. Description of the Prior Art

Teething is the process in which an infant's teeth begin to grow. During the teething process, infants chew on objects to ease the irritation associated with new teeth passing through gum tissue and to speed the process. Most infants will attempt to chew on anything that is readily available. Such chewing can be hazardous if the baby chews on objects that are made of harmful substances or that can be swallowed by the infant. Therefore, the mother typically has a teething ring available as a substitute for the harmful objects that an infant might want to chew on.

Like many women, mothers of teething infants like to present themselves with a fashionable appearance. Part of such presentation includes the wearing of jewelry, such as necklaces, bracelets and the like. Such jewelry often includes stones and beads. Teething infants often grab necklaces and chew on the stones or beads. Since some stones and beads can break off or are may be made of harmful materials, the wearing of typical jewelry while caring for teething infants might be inadvisable.

Therefore, there is a need for jewelry items that are fashionable and that are made of materials that provide effective chewing surfaces for teething infants.

### SUMMARY OF THE INVENTION

In one embodiment, the invention is a jewelry item that includes a plurality of objects that are made of a material that is suitable for infant teething and that have an outward appearance resembling a stone, a bead or other decorative ornamental object. The objects are made from a material that is a non-toxic substance that will retain its structural integrity when subjected to the forces and environment of a baby chewing on the object.

In another aspect, the invention is a teething toy for infants that includes a string member having a first end and an opposite second end and a plurality of styrene-acrylonitrile resin decorative members. Each of the plurality of styrene-acrylonitrile resin decorative members defines a longitudinal bore passing therethrough so that the decorative members are strung together by the string member. At least one decorative member of the plurality of decorative members includes a plurality of raised teething nubs extending outwardly from at least one surface of the decorative member.

In another aspect, the invention is a method of making a teething necklace in which a non-toxic resilient material is formed into a plurality of structures that have an ornamental outward appearance so that each of the plurality of structures defines a longitudinal bore passing therethrough. Each of the plurality of structures are strung together by passing a string member through the longitudinal bore defined by each of the structures.

### BRIEF DESCRIPTION OF THE FIGURES OF THE DRAWINGS

FIG. 1 is a plan view of one embodiment of the invention.

FIG. 2 is an elevational view of the embodiment of FIG. 1 shown in use.

FIG. 3A is a front elevational view of one embodiment of a cobble according to one embodiment of the invention.

FIG. 3B is a side elevational view of the coble shown in FIG. 3A.

FIG. 4A is a front elevational view of an embodiment of a coble that employs a logo.

FIG. 4B is a rear elevational view of the embodiment shown in FIG. 4A.

FIG. 5 is a perspective view of an embodiment of a coble that employs teething nubs.

FIG. 6 is an elevational view of an embodiment of a coble that has a natural stone-like appearance.

FIG. 7 is an elevational view of a decorative member according to one embodiment that employs a gemstone-like form.

FIG. 8 is an elevational view of a decorative member according to one embodiment that employs a bead-like form.

FIGS. 9A-9B are elevational views of decorative clasp member.

FIG. 10 is an elevational view of an embodiment used as a bracelet.

FIG. 11 is a graphic image of a an embodiment of a coble employing a logo.

FIG. 12 is a graphic image of an embodiment of a coble employing teething nubs.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

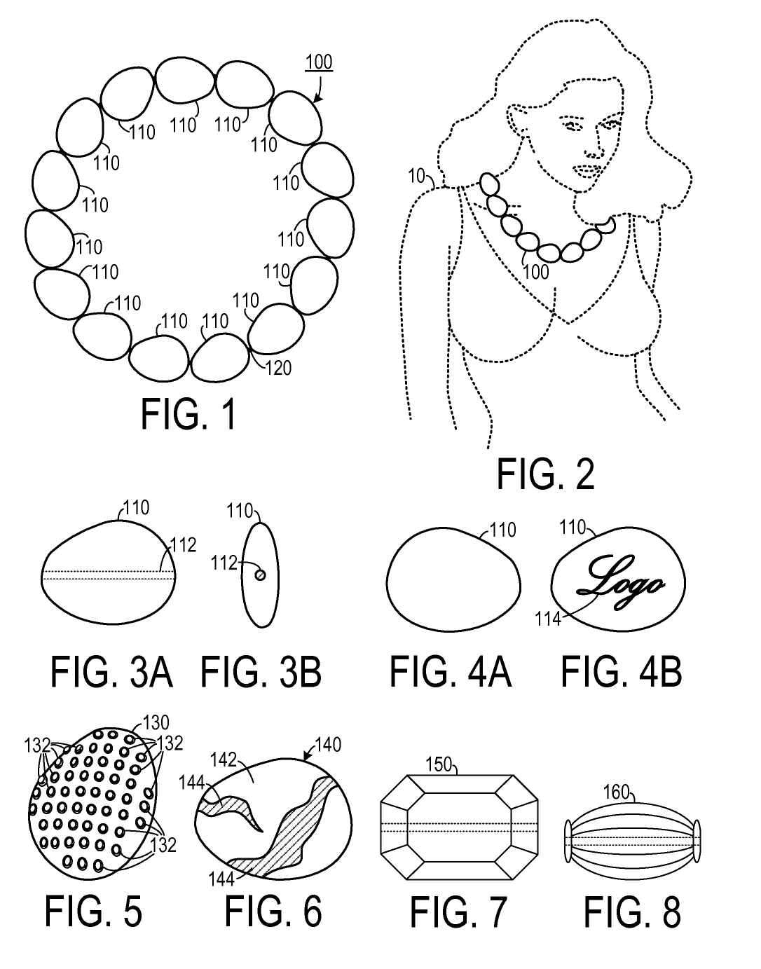

As shown in FIG. 1, one embodiment of the invention is a necklace 100 that employs a series of coble-like (or bead-like or gemstone-like) decorative members 110 that are strung on a string member 120, such as a nylon or cotton chord. The decorative members 110 are suitable as a teething accessory for an infant. Thus, they would typically be too large to be swallowed and become a choking hazard and they would be made from a non-toxic material that will not break off when subjected to a teething environment. The necklace 100 will comply with applicable safety standards (see, e.g., 21 CFR 177) and, as such, it may be made of a plastic, such as styrene-acrylonitrile resin (or another non-toxic resilient material, including, but not limited to: an acrylonitrile butadiene styrene, a styrene, a silicone, a synthetic rubber or a natural rubber). The decorative members 110 may be made using one of the known processes for forming the material selected, such as injection molding. In one example, a necklace 100 includes fifteen solid plastic decorative members 110 that are strung together.

As shown in FIG. 2, the necklace 100 is fashionable when worn by a mother 10, but also provides a suitable and safe teething surface for an infant.

As shown in FIGS. 3A and 3B, one embodiment of a decorative member 110 has a longitudinal bore 112, through which a chord may be threaded, extending therethrough. As shown in FIGS. 4A and 4B, one or more of the decorative members 110 may include a logo 114 placed on one side. The logo 114 may be cast into the decorative member 110, it may be printed on the decorative member with a non-toxic permanent ink, or it may be applied in any manner that results in a non-toxic surface that will not become dislodged through teething action.

As shown in FIG. 5, one or more of the decorative members 130 may include a plurality of raised teething nubs 132 extending outwardly therefrom.

As shown in FIG. 6, the material used to form a decorative member 140 can include a first portion 142 of a first color and a second portion 144 of a second color, different from the first color, to give the decorative member 140 the appearance of a natural stone, such as marble. As shown in FIG. 7, the decorative member may be formed in the shape of a gem stone 150 and also, as shown in FIG. 8, as a decorative bead 160.

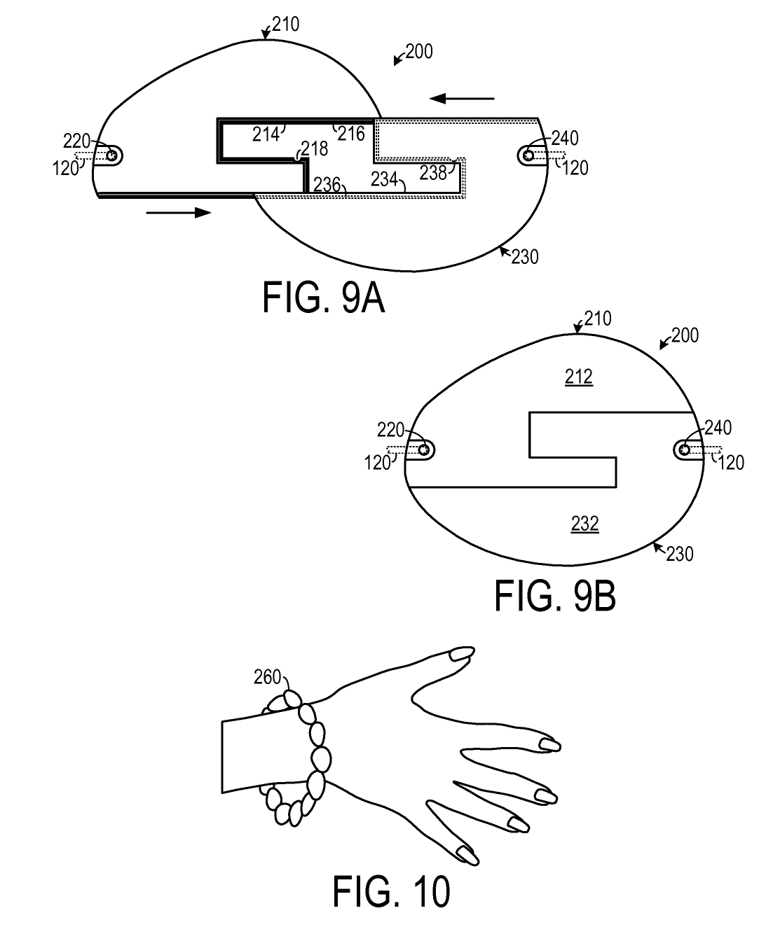

A decorative clasp member 200 is shown in FIGS. 9A and 9B. The clasp member 200 is used to secure the first end of the string member to the second end of the string member. The clasp member 200 includes a first portion 210 and a second portion 230 that is slidably engageable with the first portion 210. When the second portion 230 is fully engaged with the first portion 210, the first portion 210 and the second portion 230 appear similar to one of the decorative members 110.

The first portion 210 includes a first angular S-shaped surface 214 and the second portion 230 includes a second angular S-shape surface 234 that is complementary in shape to the first angular S-shaped surface 214. The first angular S-shaped surface 214 defines a first track 216 and the second angular S-shaped surface 234 defines a second track 236 that is engageable with the first track 216. The first angular S-shaped surface 214 also defines an indentation 218 and the second angular S-shaped surface 234 defines a detent 238 that is complementary in shape to the indentation 218 and that is engageable therewith. When the first portion 210 is engaged with the second portion 230, the detent 238 engages the indentation 218 thereby inhibiting separation of the first portion 210 from the second portion 230. Rather than using a clasp member, in one embodiment the wearer ties ends of the string member 120 together in order to wear the necklace.

The first portion 210 defines a first hole 220 passing therethrough and the second portion 230 defines a second hole 240 passing therethrough. The first hole 220 is configured to receive therethrough the first end of the string member 120 and the second hole 240 is configured to receive therethrough a second end of the string member 120.

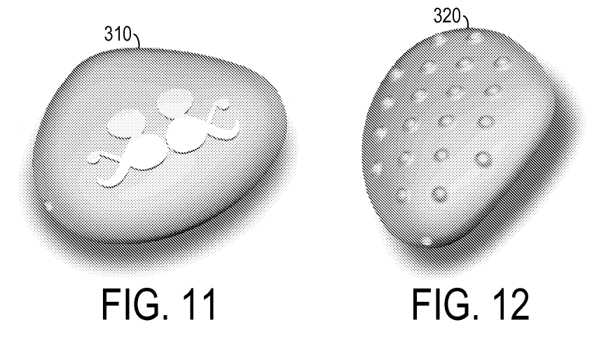

An embodiment configured as a bracelet 260 is shown in FIG. 10. A graphic image of a decorative member 310 employing a logo is shown in FIG. 11. The logo could appear on one of the decorative members or on the clasp member, or on both. A graphic image of a decorative member 320 employing teething nubs is shown in FIG. 12.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A jewelry item, comprising a plurality of decorative members, each decorative member consisting of a material that is suitable as a teething surface for an infant and each decorative member having an outward appearance corresponding to a selected one of a stone or a bead.

2. The jewelry item of claim 1, wherein the decorative members comprises styrene-acrylonitrile resin.

3. The jewelry item of claim 1, wherein at least one decorative member of the plurality of decorative members includes a plurality of raised teething nubs extending outwardly from at least one surface of the decorative member.

4. The jewelry item of claim 1, wherein each of the decorative members define a longitudinal bore passing therethrough and further comprising a string member passing through each longitudinal bore so as to string each of the decorative members together.

5. The jewelry item of claim 4, further comprising a decorative clasp member, including:
a. a first portion; and
b. a second portion that is slidably engageable with the first portion so that when the second portion is fully engaged with the first portion, the first portion and the second portion together take the form of one of the decorative members.

6. The jewelry item of claim 5, wherein the first portion includes a first angular S-shaped surface and wherein the second portion includes a second angular S-shape surface that is complementary in shape to the first angular S-shaped surface.

7. The jewelry item of claim 6, wherein the first angular S-shaped surface defines a first track and wherein the second angular S-shaped surface defines a second track that is engageable with the first track.

8. The jewelry item of claim 6, wherein the first angular S-shaped surface defines an indentation and wherein the second angular S-shaped surface defines a detent that is complementary in shape to the indentation and engageable therewith, the indentation and the detent configured so that when the first portion is engaged with the second portion, the detent engages the indentation thereby inhibiting separation of the first portion and the second portion.

9. The jewelry item of claim 5, wherein the first portion defines a first hole therethrough and wherein the second portion defines a second hole therethrough, the first hole configured to receive therethrough a first end of the string member and the second hole configured to receive therethrough a second end, opposite from the first end, of the string member.

10. The jewelry item of claim 9, wherein the string member comprises a nylon chord.

11. A teething toy for infants, comprising:
a. a string member having a first end and an opposite second end; and
b. a plurality of styrene-acrylonitrile resin decorative members that each define a longitudinal bore passing therethrough so that the decorative members are strung together by the string member, at least one decorative member of the plurality of decorative members including a plurality of raised teething nubs extending outwardly from at least one surface of the decorative member.

12. The teething toy of claim 11, further comprising a clasp member configured to selectively engage the first end of the string member to the second end of the string member, the clasp member comprising:
a. a first portion; and
b. a second portion that is slidably engageable with the first portion so that when the second portion is fully engaged with the first portion, the first portion and the second portion together take the form of one of the decorative members.

13. The teething toy of claim 12, wherein the first portion includes a first angular S-shaped surface and wherein the second portion includes a second angular S-shape surface that is complementary in shape to the first angular S-shaped surface.

14. The teething toy of claim 13, wherein the first angular S-shaped surface defines a first track and wherein the second angular S-shaped surface defines a second track that is engageable with the first track.

15. The teething toy of claim 13, wherein the first angular S-shaped surface defines an indentation and wherein the second angular S-shaped surface defines a detent that is complementary in shape to the indentation and engageable therewith, the indentation and the detent configured so that when the first portion is engaged with the second portion, the detent engages the indentation thereby inhibiting separation of the first portion and the second portion.

16. The teething toy of claim 12, wherein the first portion defines a first hole therethrough and wherein the second portion defines a second hole therethrough, the first hole configured to receive therethrough a first end of the string member and the second hole configured to receive therethrough a second end, opposite from the first end, of the string member.

17. The teething toy of claim 12, wherein each decorative member having an outward appearance corresponding to a selected one of a stone or a bead.

18. The teething toy of claim 11, wherein the string member comprises a nylon chord.

19. A method of making a teething necklace, comprising the actions of:
a. forming a non-toxic resilient material into a plurality of structures that have an ornamental outward appearance, each of the plurality of structures defining a longitudinal bore passing therethrough; and
b. stringing together each of the plurality of structures by passing a string member through the longitudinal bore defined by each of the structures.

20. The method of claim 19, wherein the non-toxic resilient material comprises an styrene-acrylonitrile resin.
